(19) United States
(12) Patent Application Publication
(10) Pub. No.: US 2005/0173454 A1
(43) Pub. Date: Aug. 11, 2005

(54) Reclosable pouring element

(76) Inventors: Wim Maas, Helmond (NL); Hans-Thomas Erd, Radolfzell (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/496,618

(22) PCT Filed: Nov. 26, 2002
(86) PCT No.: PCT/EP02/13257

(30) Foreign Application Priority Data
Nov. 26, 2001 (DE) 101 57 685.4

(51) Int. Cl. B67D 5/00

(52) U.S. Cl. 222/81; 222/92; 222/479; 222/556

(57) ABSTRACT

Illustrated and described is a reclosable pouring element for application to a multi-layer composite package, especially rectangular cardboard/plastic composite package, with a base body (1) and a pouring tube (3) joined flexibly to the base body in one piece, which at the same time is constructed as an opening element for piercing the package wall of the package in a zone of weakening provided therefor, and a package provided therefor. In order to achieve that a reliably opening and reclosing pouring element is obtainable with a small overall height, which is as user-friendly as possible for the consumer in every respect, it is provided that the pouring tube (3) is joined to the base body (1) by a circumferential flexible membrane (4) and is folded flat in the closed state so that the folded-flat pouring tube (3) is clamped between a clamping edge (8) and a clamping cross-piece (10) of the base body (1) in a sealing fashion.

The invention relates to a reclosable pouring element for application to a multi-layer composite package, with a base body and a pouring tube joined flexibly to the base body in one piece, which at the same time is constructed as an opening element for piercing the package wall of the package in a zone of weakening provided therefor, and a package provided therefor.

Multi-layer composite packages are known in a plurality of executions, for example, as flat-top composite packages or as stand-up pouches. They are mainly used in the field of liquid packaging in connection with cold, cold-sterile, hot and aseptic filling. Whereas these packages were initially not reclosable, now such packages are almost exclusively available on the market with reclosable pouring elements.

Multi-layer composite packages are known, which are provided with a pouring element which serves to open the package for the first time and is equipped with a suitable closure element so that it is reclosable (EP 0 580 593 B1). In the region of the cardboard layer and the outer polyethylene layer of the composite material of the package there is provided a dividing line to weaken the gable material in which an opening element joined in one piece to the pouring element is pressed into the package material to open the package. There is also attached to the base body of this known pouring element a cover which serves to reclose the package.

A further development is described in DE 197 27 996 C2. The pouring element known therefrom has a pouring tube which at the same time serves as an opening element to pierce the package wall. However, this known pouring element is disadvantageous in several respects. On the one hand, this pouring element has a relatively large overall height which is unfavourable with respect to transport, storage etc. of the packages provided with it. On the other hand, a secure and tight (re-)closure is not reliably solved with this pouring element. In addition, this known pouring element has a fixed swivelling axis so that the membrane partly surrounds the pouring tube and is damaged in the area of the swivelling axis after repeated actuation of the pouring element, which again leads to leakage of the package. Finally, with the known pouring element the opening of the closed pouring element points away from the pouring edge of the composite package; this requires an atypical movement by the consumer during opening.

The object of the invention is thus to improve the pouring element specified initially and described in detail previously, such that a reliably opening and re-closing pouring element is obtainable with a small overall height which is as user-friendly as possible for the consumer in every respect.

This object is achieved according to the invention by the pouring tube being joined to the base body by a circumferential flexible membrane and being folded flat in the closed state so that the folded-flat pouring tube is clamped between a clamping edge and a clamping cross-piece in a sealing fashion.

According to the invention, it has been achieved that, by folding flat the pouring tube, the overall height of the pouring element could be significantly reduced which leads to better stackability and a more harmonious design. Since a “flat sealing” of the pouring tube is accomplished by the folding flat and clamping in, the pouring element according to the invention is also reliably sealed after reclosure so that, for example, the package can be shaken without any problems, without any of the product being able to escape.

Another teaching of the invention provides that the pouring tube and/or the membrane has reinforcements which serve as an opening element. In this way, it is ensured that the weakened package material below the pouring element can be reliably destroyed when the package is first opened.

In a preferred further embodiment of the invention the opening of the pouring tube in the closed state points in the direction of the pouring edge of the package so that it is possible for the consumer to make a “normal opening movement” by lifting the closure from the front.

A further teaching of the invention provides that the pouring tube has at least one ventilation channel. More suitably, this ventilation channel protrudes over the pouring tube on the package side and the protruding part of the ventilation channel also serves as an opening element. The ventilation channel preferably has several individual channels whose cross-section tapers conically away from the opening of the ventilation channel. With such an arrangement a valve effect is achieved during the opening process which ensures that the ventilation channel always has an adequate cross-section.

It is of course understood that the part of the ventilation channel lying in the pouring tube cannot extend as far as the opening of the pouring tube so as not to prevent this opening being securely folded flat. However, this is also not necessary, it being sufficient for a good ventilation function that the ventilation channel lies above the product jet and extends inside the package. The cross-section of the ventilation channel can be a polygon, preferably hexagonal, or round or oval.

In order that the package wall can be reliably destroyed in all cases in the area of the zone of weakening, a further teaching of the invention provides that the lower part of the ventilation channel serving as an opening element is provided with a cutting edge or the like.

In a further development of the invention it is provided that the pouring tube has further reinforcing cross-pieces protruding over the pouring tube on the package side, which support the opening process and when the pouring element has been opened, ensure that the package material is held open. In an advantageous embodiment these reinforcing cross-pieces are constructed as profiled in order to achieve better rigidity. For example, an angle section is possible here. These reinforcing cross-pieces are more suitably attached in the extension of the pouring tube in order to achieve a defined pouring cross-section.

According to a further teaching of the invention, in the opened position the pouring tube has a polygonal, round or oval cross-section. In this way, an optimum pouring cross-section is always achieved and it is also possible to use the pouring tube as a “mouthpiece” at the same time.

For reliable emptying of the entire package contents the hinge angle of the pouring tube of the pouring element according to the invention is preferably between 30° and 90°. However, when stand-up pouches are used, hinge angles between 20° and 170° are feasible.

In a further embodiment of the invention, the folded-flat opening of the pouring tube is held tightly closed by means of a clamping edge provided at the base body. In this way, it is reliably prevented that any contamination can penetrate inside the pouring tube before it is first used and in addition, there is an “acknowledgement” during reclosure for the consumer, whereby the folded-flat pouring tube is clipped into the clamping edge in the closed or reclosed state so that an acoustic and tactile perception is possible. In order to achieve particularly secure flat folding, the wall of the pouring tube has a plurality of pre-determined folding points which act like film hinges.

A further teaching of the invention provides that the pouring element has an originality seal. Preferably provided as the originality seal is a joint between the flat-folded pouring tube and the base body which is destroyed when the pouring element is opened for the first time.

The invention further relates to a flat-top package, especially rectangular cardboard/plastic packaging which is optimally suitable for application of the base body. It quickly becomes apparent that reliable piercing of the package wall in the area of the zone of weakening is only achieved if the position of the pouring element exactly matches that of the zone of weakening. The pouring element is preferably, depending on the material, applied to the package by hot-melt adhesion or by means of ultrasonic or high-frequency welding. The weakening of the package material in the zone of weakening can be accomplished by perforation, preferably laser perforation, and/or hot air activation.

The invention is explained in greater detail in the following with reference to the drawings which show a preferred embodiment wherein:

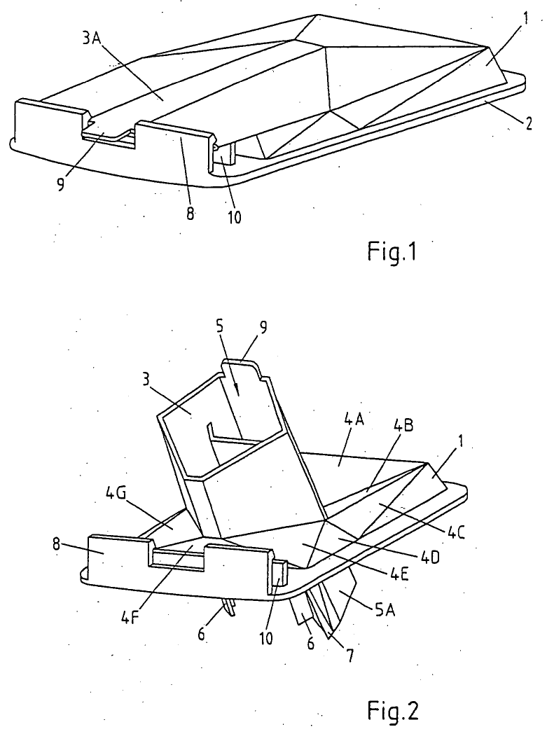

FIG. 1 is a perspective view of the pouring element in the closed position, without the composite package,

FIG. 2 is a perspective view of the pouring element from FIG. 1 in the open position,

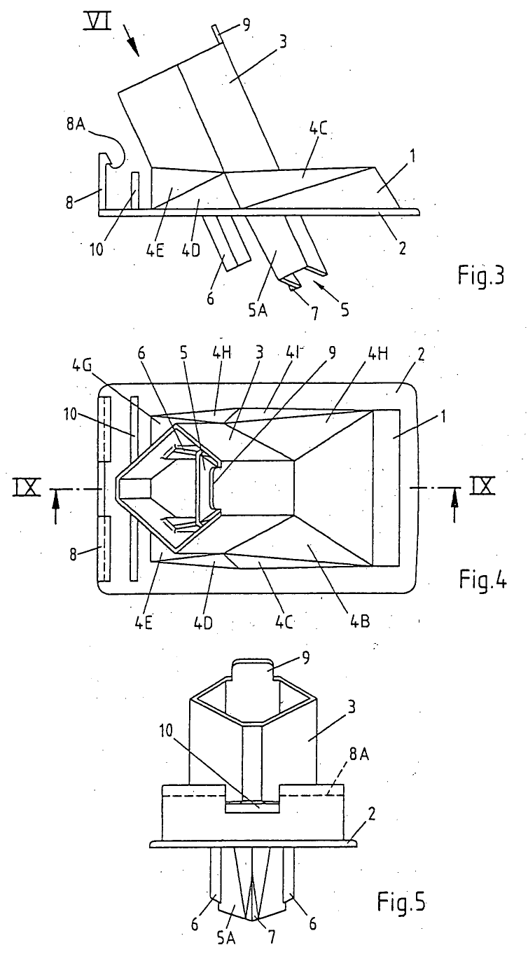

FIG. 3 is a side view of the pouring element from FIG. 2,

FIG. 4 is a top view of the pouring element from FIG. 2,

FIG. 5 is a side view from the front of the pouring element from FIG. 2,

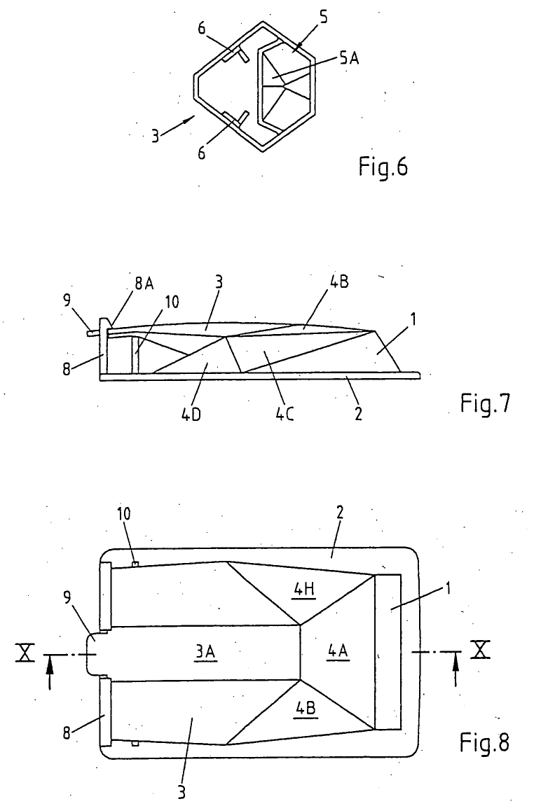

FIG. 6 is a top view of the pouring channel of the pouring element from FIG. 2 in the direction of arrow VI in FIG. 3,

FIG. 7 is a side view of the pouring element from FIG. 1,

FIG. 8 is a top view of the pouring element from FIG. 1,

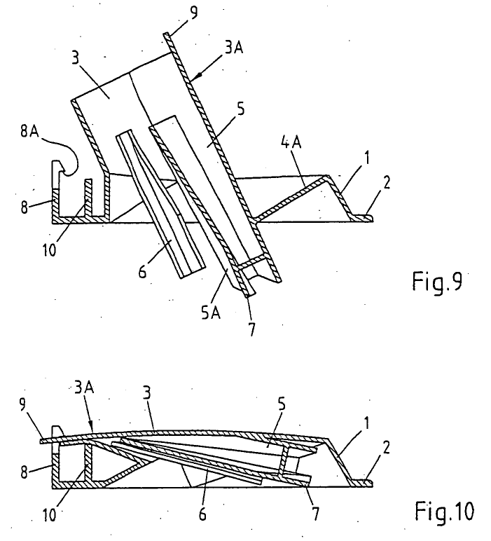

FIG. 9 is a longitudinal section through the pouring element from FIG. 4 along the line IX-IX and

FIG. 10 is a longitudinal section through the pouring element from FIG. 8 along the line X-X.

FIG. 1 shows a pouring element according to the invention in the closed position and specifically in the form as it is applied to a package (not shown). It substantially consists of a frame-like base body 1 with a circumferential application flange 2 and a pouring tube 3 which is only completely identifiable in the opened position as in FIG. 2. Only the folded-flat upper side 3A of this pouring tube 3 can be identified in FIG. 1. The pouring tube 3 is surrounded by a circumferential flexible membrane 4 which is again joined in one piece to the base body 1. In the embodiment shown and insofar preferred, the membrane 4 has a plurality of square or triangular individual areas of which areas 4A to 4G are identifiable in FIG. 2.

For a better representation, the pouring element in perspective view from FIG. 2 is shown in three different perspectives in FIGS. 3 to 5 and in a longitudinal section in FIG. 9. A ventilation channel 5 inside the pouring tube 3 and the reinforcing cross-pieces 6 supporting the opening process can clearly be seen, wherein in the opened position, both the ventilation channel 5 and also the reinforcing cross-pieces 6 serve to keep free a defined pouring transverse cross-section of the package material pressed away to the side during opening of the package. As described further above, the ventilation channel 5 protrudes over the pouring tube 3 at the side of the package and the protruding part 5A of the ventilation channel 5 is at the same time constructed as an opening element. For this purpose the protruding part 5A of the ventilation channel 5 preferably has a cutting edge 7 at its lower end, which can be identified particularly clearly in FIGS. 2 and 5.

The perspective view in FIG. 2 shows the pouring element just as it leaves the injection mould after the injection moulding process, namely with the pouring tube 3 opened. In the embodiment shown and insofar preferred, the pouring tube 3 has a hexagonal cross-section which can be identified clearly in FIG. 6. According to a further teaching of the invention, the wall of the pouring tube 3 has a plurality of pre-determined folding points 11. This geometry of the pouring tube 3 is especially suitable for the pouring tube 3 to be able to be folded completely flat when the pouring element is closed.

At the anterior edge of the circumferential application flange 2 can be identified a clamping edge 8 which, in the upper region, has a projection 8A pointing towards the pouring tube, which can be identified particularly clearly in FIG. 3. Furthermore, the clamping edge 8 is recessed in its central region in order to be able to accommodate a projection 9 serving as an opening aid (an extension of the upper side 3A of the opening tube 3) of the opening tube 3.

After the pouring element has left the mould, the pouring tube 3 is folded flat and takes on the form shown in FIGS. 1, 7, 8 and 10. In this case, the ventilation channel 5 “disappears” inside the base body 1, as can be seen particularly clearly from FIG. 10. The small overall height of the pouring element according to the invention can be seen, which contributes substantially to an attractive aesthetic overall impression of the pouring element and to good stackability of the packages provided with it.

The folded-flat pouring tube 3 is curved over a clamping cross-piece 10 projecting upwards from the base body 1 with slight pre-stressing, as can be deduced especially clearly from FIGS. 7 and 10. By this means, the pouring tube 3 is pressed flat together by the clamping cross-piece 10 from below and by the clamping edge 8 from above so that its opening is reliably closed in a sealed fashion. This allows a re-closed drink package provided with a pouring element according to the invention to be shaken without dripping and further ensures that any penetration of dust, moisture etc., is reliably prevented.

The pouring element according to the invention can also have an originality seal (not shown) which can, for example, be arranged between the clamping edge 8 and the folded-flat pouring tube 3 and is destroyed when the package provided with a pouring element according to the invention is opened for the first time, so that the consumer can see at a glance whether the package is still in the unopened state or not.

In the embodiment shown and insofar preferred, the hinge angle is approximately 65°. This is sufficient for completely drip-free-emptying of the package but technically any hinge angle between 30° and 90° is possible. If the pouring element according to the invention is used with stand-up pouches, hinge angles between 20° and 170° are also feasible.

It is naturally understood that the pouring element according to the invention is to be applied to the composite package exactly in the area of the zone of weakening, so that on opening, the zone of weakening of the composite package can be reliably destroyed in order to reliably achieve a sufficiently large opening cross-section. The pouring element is preferably arranged on the package so that in the closed state, the opening of the pouring tube 3 points towards the pouring edge of the package in order to achieve maximum user comfort.

1-24. (canceled)

25. A reclosable pouring element for use with a multi-layer composite package, wherein the reclosable pouring element is comprised of a base body and a pouring tube joined flexibly to the base body in one piece, wherein the pouring tube is configured as an opening element for piercing a package wall of the package in a zone of weakening of the package, further wherein the pouring tube is joined to the base body by a circumferential flexible membrane and is folded flat in a closed state so that the folded-flat pouring tube is clamped between a clamping edge and a clamping cross-piece of the base body in a sealing fashion.

26. The pouring element according to claim 25, wherein one of the pouring tube and the membrane has reinforcements, wherein the reinforcements serve as an opening element.

27. The pouring element according to claim 25, wherein the opening of the pouring tube points in the direction of the pouring edge of the package when the pouring tube is in the closed state.

28. The pouring element according to claim 27, wherein the pouring tube has at least one ventilation channel.

29. The pouring element according to claim 28, wherein the ventilation channel protrudes over the pouring tube on a side of the package forming a protruding part, wherein the protruding part of the ventilation channel also serves as an opening element.

30. The pouring element according to claim 29, wherein the pouring tube includes reinforcing cross-pieces protruding over the pouring tube on a package side, wherein the reinforcing cross-pieces cause package material to be held open when the pouring element is opened.

31. The pouring element according to claim 30, wherein the reinforcing cross-pieces are profiled.

32. The pouring element according to claim 29, wherein the ventilation channel includes a cutting edge as an opening aid on the side of the package.

33. The pouring element according to claim 32, wherein the ventilation channel includes a hexagonal cross-section in an opened position.

34. The pouring element according to claim 32, wherein the ventilation channel includes a plurality of individual channels.

35. The pouring element according to claim 32, wherein the cross-section of the ventilation channel tapers conically away from the opening.

36. The pouring element according to claim 35, wherein the pouring tube includes a polygonal cross-section in an opened position.

37. The pouring element according to claim 36, wherein the pouring tube includes a hexagonal cross-section in the opened position.

38. The pouring element according to claim 35, wherein the pouring tube includes one of a round and oval cross-section in the opened position.

39. The pouring element according to claim 35, wherein a wall of the pouring tube includes a plurality of pre-determined folding points.

40. The pouring element according to claim 27, wherein a hinge angle of the pouring tube is between 30° and 90°.

41. The pouring element according to claim 25, wherein the pouring element includes an originality seal.

42. A multi-layer composite package including a reclosable pouring element, wherein the reclosable pouring element is comprised of a base body and a pouring tube joined flexibly to the base body in one piece, wherein the pouring tube is configured as an opening element for piercing a package wall of the package in a zone of weakening of the package, further wherein the pouring tube is joined to the base body by a circumferential flexible membrane and is folded flat in a closed state so that the folded-flat pouring tube is clamped between a clamping edge and a clamping cross-piece of the base body in a sealing fashion.

43. The package according to claim 42, wherein the pouring element is attached by hot-melt adhesion.

44. The package according to claim 42, wherein the pouring element is attached by ultrasonic welding.

45. The package according to claim 42, wherein the pouring element is attached by high-frequency welding.

46. The package according to claim 42, wherein the zone of weakening is weakened by means of one of a perforation and hot-air activation.

47. The package according to claim 46, wherein the perforation is a laser perforation.

48. The package according to claim 42, wherein the pouring element is arranged on the package so that the opening of the pouring tube points towards the pouring edge of the package in the closed state.
